(19) United States
(12) Patent Application Publication
(10) Pub. No.: US 2006/0168571 A1
(43) Pub. Date: Jul. 27, 2006

(54) System and method for optimized task scheduling in a heterogeneous data processing system

(75) Inventors: Soraya Ghiasi, Austin, TX (US); Thomas Walter Keller JR., Austin, TX (US); Ramakrishna Kotla, Austin, TX (US); Freeman Leigh Rawson III, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/044,607

(22) Filed: Jan. 27, 2005

(51) Int. Cl. G06F 9/44

(52) U.S. Cl. 717/127

(57) ABSTRACT

A method, computer program product, and a data processing system for optimizing task throughput in a multi-processor system. A performance metric is calculated based on performance counters measuring characteristics of a task executed at one of a plurality of processor frequencies available in the multi-processor system. The characteristics measured by the performance counters indicate activity in the processor as well as memory activity. A performance metric provides a means using measured data at one available frequency to predict performance at another processor frequency available in the multi-processing system. Performance loss minimization is used to assign a particular task to a particular frequency. Additionally, the present invention provides a mechanism for priority load balancing of tasks in a manner that minimizes cumulative performance loss incurred by execution of all tasks in the system.

### BACKGROUND OF THE INVENTION

1. Technical Field

The present invention relates generally to an improved data processing system and in particular to a data processing system and method for scheduling tasks to be executed by processors. More particularly, the present invention provides a mechanism for scheduling tasks to processors of different frequencies, which can adequately provide the tasks' computational needs. Still more particularly, the present invention provides a mechanism for scheduling a task to processors of different frequencies in a manner that optimizes utilization of a multi-processor system processing capacity.

2. Description of Related Art

Multiple processor systems are well known in the art. In a multiple processor system, a plurality of processes may be run and each process may be executed by one or more of a plurality of processors. Each process is executed as one or more tasks which may be processed concurrently. The tasks may be queued for each of the processors of the multiple processor system before they are executed by a processor.

Applications executed on high-end processors typically make varying load demands over time. A single application may have many different phases during its execution lifetime, and workload mixes consisting of multiple applications typically exhibit interleaved phases. Application execution phases may generally be characterized as memory-intensive and CPU-intensive.

Contemporary processors provide resources that are underutilized during memory intensive phases and may increasingly consume larger amounts of power while producing little incremental gain in performance—a phenomena known as performance saturation. Executing performance saturated tasks on a processor at frequencies beyond a certain speed results in little, if any, gain in the task execution performance, yet causes increased power consumption.

It is known that a single application is composed of different phases. Modern processor design and research has attempted to exploit variability in processor workloads. Examining an application at different granularities exposes different types of variable behavior which can be exploited to reduce power consumption. Long-lived phases can be detected and exploited by the operating system. Frequency and voltage scaling are mechanisms used by operating systems to reduce power when running variable workloads.

Various mechanisms have been developed that utilize frequency and voltage scaling with heterogeneous processors in attempt to control the average or the maximum power consumed by data processing systems. For example, LongRun by Transmeta Corporation of Santa Clara, Calif., and Demand Based Switching by Intel Corporation of Santa Clara, Calif., both respond to changes in processor demand but do so on an application-unaware basis. In both systems, an increase in CPU utilization leads to an increase in frequency and voltage while a decrease in utilization leads to a corresponding decrease in frequency and voltage. Neither system makes any use of information regarding how efficiently the workload uses the processor or how the workload affects memory behavior. Rather, these systems rely on simple metrics, such as non-halted cycle counts during an interval of time.

Other works have included methods of using dynamic frequency and voltage scaling in the Linux operating system and focus on average power and total energy consumption. For example, an examination of laptop applications and the interaction between the system and the user has been made to determine the slack due to processor over-provisioning. These methodologies implement frequency and voltage scaling to reduce power while consuming the slack by running the computation slower. Other efforts have extended these systems to accommodate deployment to web server farms. For example, the use of request batching to gain larger reductions in power during periods of low demand has been addressed.

However, none of the previous approaches provide a mechanism for responding to changes in memory subsystem demands rather than changes in CPU utilization metrics. Thus, it would be advantageous to utilize simple metrics, such as memory hierarchy performance counters, for identifying a processor frequency most ideal for execution of an application phase. It would be further advantageous to provide a mechanism for identifying ideal processor frequencies for execution of an application phase in a multiprocessor system. It would also be advantageous to provide a mechanism for minimizing performance penalties resulting from executing memory intensive application phases at slower, less power-consumptive processor frequencies.

### SUMMARY OF THE INVENTION

The present invention provides a method, computer program product, and a data processing system for optimizing task throughput in a multi-processor system. A performance metric is calculated based on performance counters measuring characteristics of a task executed at one of a plurality of processor frequencies available in the multi-processor system. The characteristics measured by the performance counters indicate activity in the processor as well as memory activity. A performance metric provides a means using measured data at one available frequency to predict performance at another processor frequency available in a multi-processing system. Performance loss minimization is used to assign a particular task to a particular frequency. Additionally, the present invention provides a mechanism for priority load balancing of tasks in a manner that minimizes cumulative performance loss incurred by execution of all tasks in the system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a multiple processor system in which a preferred embodiment of the present invention may be implemented;

FIG. 2 is an exemplary plot of normalized throughput versus normalized processor frequency for various workloads with different ratios of memory to CPU activity, showing their saturation points;

FIG. 3 is a flowchart of an initialization subroutine of a task-to-frequency scheduling routine implemented in accordance with a preferred embodiment of the present invention;

FIG. 4 is a diagrammatic illustration of a task-to-frequency scheduler and task bins for initial task scheduling according to a preferred embodiment of the present invention;

FIG. 5 is a flowchart depicting processing of a task-to-frequency scheduler subroutine for assigning tasks in task bins to processor queues in accordance with a preferred embodiment of the present invention; and

FIG. 6 is a flowchart of processing performed by a balancing routine of a scheduler for load balancing of tasks according to task-to-frequency optimization implemented in accordance with a preferred embodiment of the present invention.

### DETAILED DESCRIPTION OF THE PREFERRED EMBODIMENT

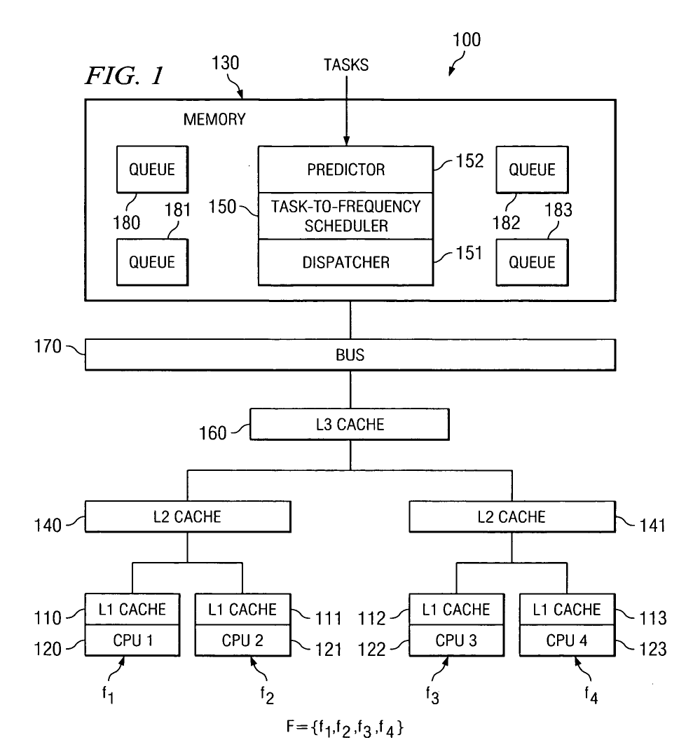

With reference now to the figures, FIG. 1 is an exemplary diagram of a multi-processor (MP) system 100 in which a preferred embodiment of the present invention may be implemented.

As shown in FIG. 1, MP system 100 includes dispatcher 151 and a plurality of processors 120-123. Dispatcher 151 assigns tasks, such as process threads, to processors in system 100. A task, as referred to herein, generally comprises one or more computer-executable instructions and may, for example, comprise instructions in a thread of a multi-threaded application, a sequence of instructions in a single threaded application, or any other set of instructions that can be identified as commonly occupying a phase of an application based on memory access performance metrics. A task is an execution path through address space. In other words, a set of program instructions is loaded in memory. The address registers have been loaded with the initial address of the program. At the next clock cycle, the CPU will start execution, in accordance with the program. As long as the program remains in this part of the address space, the task can continue, in principle, indefinitely, unless the program instructions contain a halt, exit, or return. A task is the schedulable unit controlled by a scheduler.

Furthermore, dispatcher 151 may be implemented as software instructions run on processor 120-123 of the MP system 100. Dispatcher 151 allocates tasks to queues 180-183 respectively assigned to processors 120-123 and maintained in memory subsystem 130. Dispatcher 151 allocates tasks to particular queues at the direction of task-to-frequency scheduler (TFS) 150. TFS 150 facilitates load balancing of CPUs 120-123 by monitoring queue loads and directing dispatch of new tasks accordingly. Additionally, TFS 150 interfaces with (or alternatively includes) a performance predictor 152 which facilitates selection of processor frequency for a given task in multi-processor system 100. Predictor 152 evaluates task performance at one of a plurality of system processor frequencies and estimates task performance and performance loss that would result by executing the task on one or more other system processor frequencies. TFS 150 schedules tasks to particular frequencies based on the evaluation made by predictor 152 in accordance with embodiments of the invention and as discussed more fully herein below.

In the illustrative example, MP system 100 has CPUs 120-123 that are set to operate at respective frequencies f₁-f₄. To facilitate an understanding of the invention, assume herein that the operational frequency f₁ of CPU 120 is the slowest operational frequency of the frequencies f₁-f₄, and that the CPU frequencies increase from f₁ to f₄, that is, CPU 123 operates at the highest processor frequency f₄ available in MP system 100. As referred to herein, the set of available CPU frequencies f₁-f₄ in MP system 100 is referred to as the system frequency set F.

MP system 100 may be any type of system having a plurality of multi-processor modules adapted to run at different frequencies and voltages. As used herein, the term “processor” refers to either a central processing unit or a thread processing core of an SMT processor. Each of CPUs 120-123 contains a respective level one (L1) cache 110-113. Each of CPUs 120-123 is coupled to a respective level two (L2) cache 140 and 141. Similarly, each of L2 caches 140 and 141 may be coupled to an optional level three (L3) cache 160. The caching design described here is one of many possible such designs and is used solely for illustrative purposes. The lowest memory level for MP system 100 is system memory 130. CPUs 120-123, L1 caches 110-113, L2 caches 140 and 141, and L3 cache 160 are coupled to system memory 130 via an interconnect, such as bus 170. Tasks are selected for placement in a queue 180-183 based on their assignment to one of processors 120-123 by TFS 150.

The present invention exploits observed changes in demands on the caches 110-113, 140-141 and 160 and the memory subsystem 130 to minimize power consumption and performance loss in MP system 100. Task-to-frequency scheduling is always performed. Task-to-frequency scheduling covers all forms of memory usage ranging from ones where the processor must wait much of the time for memory operations to complete to ones where the processor waits for memory only occasionally. When the processor waits for a cache or memory operation to complete, the processor is said to “stall”, and such events are known generically as “memory stalls.” TFS is a replacement for the task scheduler of an operating system. TFS also may be used to supplement an existing task scheduler. During CPU-intensive phases, tasks are assigned to a processor running at full voltage and frequency, while tasks in memory-intensive phases are assigned to a processor running at a slower frequency and thus, possibly, a lower voltage. Processors 120-123 are preferably implemented as respective instances of a single processor generation that may be run at different frequencies and voltages. For example, processors 120-123 may be respectively implemented as PowerPC processors available from International Business Machines Corporation of Armonk, N.Y.

In accordance with an embodiment of the present invention, the TFS runs a modeling routine, or predictor 152, that facilitates scheduling of tasks to a processor core of a particular frequency and voltage by identifying an ideal frequency at which the task may be performed and predicting performance of the task if run at a lower frequency. A performance loss of the task at the lower frequency and voltage is evaluated to determine what system processor frequency to schedule the task to. That is, the predictor routine evaluates predicted performance of a task and facilitates selection of one of a set of heterogeneous processors to execute the task by determining a frequency based on memory demands of the task. Scheduler 150 uses the evaluation of the predictor and load balancing requirements to generate an appropriate allocation of tasks to processor frequencies. The TFS routine is based on the premise that a limited benefit in task execution is realized by increasing processor performance beyond a particular, task- and phase-specific point. The point of processor capacity at which little, if any, increase in task execution performance is realized with an increase in processor performance capacity is referred to herein as the “performance saturation point.” A task executed above its saturation point is referred to herein as a “performance saturated task.” Performance saturation is due to the fact that memory is generally much slower than processor speed. Thus, at some point, the speed of task execution is bounded by the memory speed. The ratio of CPU-intensive to memory-intensive work in a task determines the saturation point.

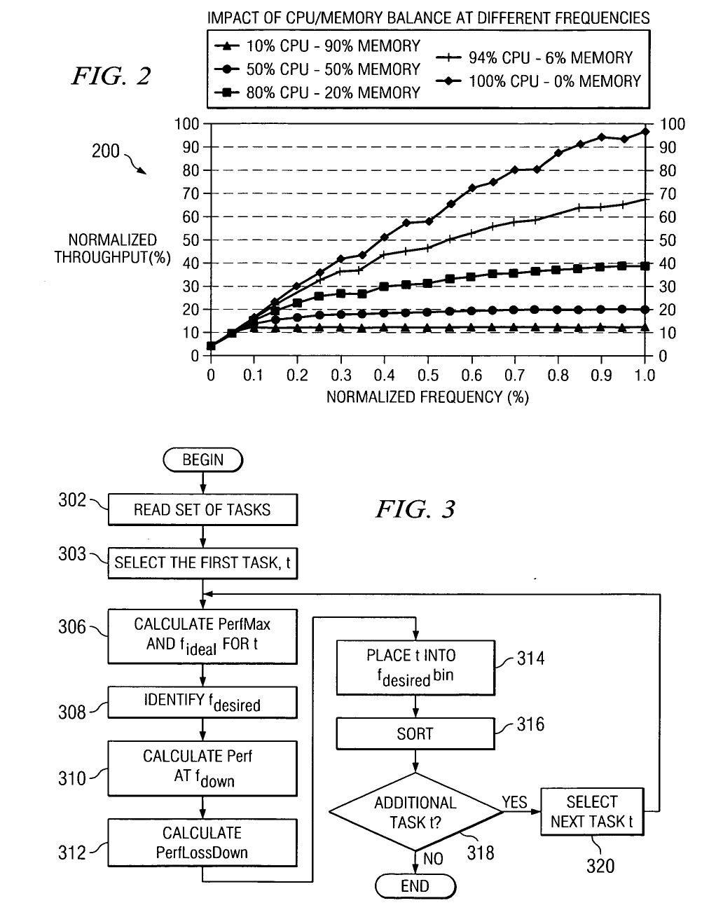

FIG. 2 is an exemplary plot of normalized throughput versus normalized processor frequency for workloads with various levels of CPU and memory intensity, and it shows the saturation point for each workload. Plot 200 illustrates that increases in processor speed result in limited benefits in program execution speed after a particular performance capability of the processor is reached. The limit at which increase in processor speed does not provide a substantial increase in program execution is related to the CPU-intensity to memory-intensity measure of the program. For example, an application having a CPU-intensity to memory-intensity ratio of 10% exhibits little performance increase, e.g., throughput, with normalized processor frequency increases above 0.1. As another example, consider an application having a CPU-intensity to memory-intensity ratio of 80%. As shown, an increase in the normalized frequency from 0.1 to 0.4 results in a normalized throughput increase of 100 percent (a normalized throughput increase from 15 to 30). However, an additional increase in normalized frequency of 0.6 (to a normalized frequency of 1) results in only an additional throughput of eight percent (a final throughput of 38%).

In accordance with a preferred embodiment of the present invention, process tasks, such as threads, are scheduled to particular processors by identifying a processor that will result in minimal performance loss for a particular set of fixed processor frequencies available, i.e., the system frequency set F, versus running the tasks on a set of processors whose frequencies are all the maximum frequency available in F.

To this end, an instruction per cycle (IPC) predictor is implemented in predictor 152 that uses a measured IPC of a task at one frequency and performance counters to predict an IPC value at any other frequency. TFS 150 then evaluates the benefit of allocating tasks to processors available in the system. A processor of the MP system is selected based on a metric of minimum performance loss. Additionally, the predictor accommodates changes in application memory and CPU intensity, that is, phase changes. Moreover, phase changes are detected to decide when to repartition the set of tasks, that is, when to change the processor to which associated tasks are allocated.

The predictor comprises an IPC model that includes a frequency-dependent and frequency-independent component. Equation 1 defines an exemplary IPC predictor calculation that may be implemented in predictor 152:

$$equation 1 \text{:}$$

$$IPC ≡ \frac{Instructions}{Cycle} = \frac{Instructions}{{C}_{stall} + {C}_{inst}} ,$$

where Cₛₜₐₗₗ is the number of cycles having stalls, e.g., branch stalls, pipeline stalls, memory stalls, and the like, and Cᵢₙₛₜ is the number of cycles in which instructions are executed. By utilizing readily available performance counters, e.g., the number of memory hierarchy references, associated latencies, and the like, equation 1 can be implemented as defined in equation 2:

$$equation 2 \text{:}$$

$$IPC = \frac{Instructions}{\begin{matrix}\frac{Instructions}{ α} + {C}_{ branch\_stalls} + \\ … + {C}_{ pipelin\_stalls} + ( {C}_{ L 2 \_stalls} + {C}_{ L 3 \_stalls} + {C}_{mem\_stalls} )\end{matrix}} \\ = \frac{1}{\begin{matrix}\frac{1}{ α} + \frac{ {C}_{ other\_stalls}}{ Instructions} + \\ \frac{1}{ Instructions} ( {N}_{ L 2} {T}_{ L 2} + {N}_{ L 3} {T}_{ L 3} + {N}_{ mem} {T}_{ mem} ) f\end{matrix}}$$

where: α is the idealized IPC of a perfect machine with infinite L1 caches and no stalls;

Instructions is the number of instructions completed;

C_{branch}_{_{—}}ₛₜₐₗₗₛ is the number processor cycles spent stalled on a branch instruction;

Cₚᵢₚₑₗᵢₙₑ_{_{—}}ₛₜₐₗₗₛ is the number of processor cycles spent stalled in the processor pipeline;

C_{L2}_{_{—}}ₛₜₐₗₗₛ is the number of processor cycles spent stalled on L2 cache accesses;

C_{L3}_{_{—}}ₛₜₐₗₗₛ is the number of processor cycles spent stalled on L3 cache accesses;

Cₘₑₘ_{_{—}}ₛₜₐₗₗₛ is the number of processor cycles spent stalled on memory accesses;

Cₒₜₕₑᵣ_{_{—}}ₛₜₐₗₗₛ is the number of stall cycles attributable to causes other than cache and memory delays;

N_{L2} is the number of L2 cache references;

T_{L2} is the latency to L2 cache;

N_{L3} is the number of L3 cache references;

T_{L3} is the latency to L3 cache;

Nₘₑₘ is the number of references to the system memory;

Tₘₑₘ is the latency to the system memory; and

f is the frequency at which the execution of the process tasks are evaluated.

The α value takes into account the instruction level parallelism of a program and the hardware resource available to extract it. Since α cannot always be determined accurately, the predictor may use a heuristic to set it. One possible heuristic is to take α to be 1 for programs with an IPC less than 1 and to take α to be the program's IPC at the maximum frequency for programs with an IPC greater than 1.

Memory stall cycles can be measured directly via performance counters on some data processing systems and can be estimated via reference counts and memory latencies on other data processing systems. This embodiment uses estimation via reference counts and memory latencies; however, this is for illustrative purposes only.

The IPC, or another performance metric derived therefrom, is calculated for a task at a particular frequency f in the system frequency set F by running a given task on one of the system processors. The frequency used need not be f since the invention allows the calculation of projected values of the performance metric at any frequency given performance data collected at a single frequency. In particular, the data may be used with equation 2 to predict the performance metric(s) at any frequency in the frequency set F. Calculation of a performance metric based on performance counters obtained by running a task on a system processor is a process performed at the end of a scheduling quantum. A scheduling quantum is the maximum duration of time a task may execute on a processor before being required to give control back to the operating system.

Thus, the IPC predictor estimates the IPC for a frequency f based on the number of cycles the processor was stalled by memory accesses. If the data processing system does not support direct performance counter measurement of memory access stalls, then the IPC predictor estimates the IPC for a frequency f based on the number Nx of occurrences of memory references and corresponding time or latencies Tₓ consumed by the event. The predictor equation described above assumes constant values for Tₓ, while in reality the time Tₓ for an event may vary. The error introduced by assuming the Tₓ values are constant is small and provides the predictor with an acceptable approximation of the IPC.

The error introduced by assuming constant Tₓ values may be minimized by a number of methods. For example, an additional linearity assumption may be made to determine memory latencies empirically. However, such a technique requires the measurement of the IPC at two different frequencies. To this end, the IPC equation may be written as a linear equation of two variables of the form af+b=1/IPC. Thus, by taking two measurements of IPC at different frequencies, two instances of the IPC equation may be solved for a and b which are then utilized to calculate the performance predictions at other frequencies. Other methods may be implemented for reducing the error introduced by assuming constant memory latencies.

The reciprocal of the IPC may be calculated to provide cycles per instruction (CPI) as defined by equation 3:

$$equation 3 \text{:}$$

$$CPI = {CPI}_{inst} + {CPI}_{mem\_stalls} + {CPI}_{other\_stalls} \\ = \frac{1}{α} + \frac{{N}_{L 2} {T}_{L 2} + {N}_{L 3} {T}_{L 3} + {N}_{mem} {T}_{mem}}{Instructions} f + \frac{{C}_{other\_stalls}}{Instructions}$$

The CPI calculation in equation 3 asymptotically reaches a CPU-intensive and a memory-intensive form. Because the CPI asymptotically reaches the two forms, those two forms can be rewritten for the IPC variants as provided by equations 4 and 5:

$$equation 4 \text{:}$$

$${IPC}_{cpu\_intensive} \approx \frac{1}{\frac{1}{ α} + \frac{1}{Instructions} ( {C}_{branch} + … + {C}_{pipeline} )} \approx α$$

$$equation 5 \text{:}$$

$${IPC}_{memory\_intensive} \approx \frac{Instructions}{( {N}_{L 2} {T}_{L 2} + {N}_{L 3} {T}_{L 3} + {N}_{mem} {T}_{mem} ) f}$$

Accordingly, at any given frequency, the predicator can predict the IPC at another frequency given the number of misses at the various levels in the memory hierarchy as well as the actual time it takes to service a miss. This provides the mechanism for identifying the optimal frequency at which to run a given phase with minimal performance loss. As expected, the more memory-intensive a phase is, as indicated by the memory subsystem performance counters, the more feasible it is to execute the phase at a lower frequency (and voltage) to save power without impacting the performance and the better that the phase fits onto a slower processor.

An exemplary throughput performance metric for evaluating the performance of a task at a particular frequency is defined as the product of the IPC calculated at a particular frequency and the frequency itself, represented by equation 6:
Perf(t, f)=IPC(t, f)*f equation 6:
The change in throughput performance resulting from execution of the task phase at a different frequency, g, is determined according to equation 7:

$$equation 7 \text{:}$$

$$PerfDelta ( t , f , g ) = \frac{Perf ( t , f ) - Perf ( t , g )}{Perf ( t , f )}$$

The throughput performance metric Perf defined by equation 6 is used for evaluating execution performance of a task t at a particular frequency f and provides a numerical value of performance throughput in instructions per second, although other performance metrics may be suitably substituted.

The predicted IPC can be translated into a more meaningful metric for calculating the performance loss of a task t at a particular frequency f. Rather than performing evaluations directly with the predicted IPC, the predicted throughput at frequency f and the processor family nominal maximum frequency fₘₐₓ are preferably used. In accordance with a preferred embodiment of the present invention, throughput is used as the metric of performance when attempting to minimize performance loss. Throughput performance is the product of IPC and frequency while performance loss is the fraction of the performance lost by running the same task at a different frequency. The incentive for using throughput as the metric for performance is apparent in view of FIG. 2 above and the discussion thereof. Performance saturated tasks gain nothing from an increase in frequency as reflected by a constant throughput value.

A maximum performance that may be attained for a given task t may then be calculated from equation 6 by calculating the performance at the maximum available system frequency fₘₐₓ, which in this particular illustrative example is f₄. Performance loss estimates are then deduced by comparing or otherwise calculating a measure of the difference in performance at the maximum system frequency with respect to another system frequency f. For example, equation 8 may be utilized for calculating the performance loss (PerfLoss) incurred by executing a given task t at a frequency f less than the maximum system frequency fₘₐₓ:

$$equation 8 \text{:}$$

$$PerfLoss ( t , f ) = \frac{Perf ( t , {f}_{max} ) - Perf ( t , f )}{Perf ( t , {f}_{max} )}$$

Performance loss estimates for individual tasks can be used to minimize the performance loss of the system as a whole. Any particular task may suffer a performance loss, but as long as the system incurs the least possible performance loss under the current frequency constraints the system performance is acceptable. The total performance loss is the sum of the performance loss of each task scheduled at each frequency. If the possible frequency settings are F=f₁, . . . , fₘ, where fₘ<=fₘₐₓ, then the total system performance loss may be calculated by the following:

$$equation 9 \text{:}$$

$$TotalPerfLoss ( T , F ) = {\sum }_{∀ t @ {f}_{1}} PerfLoss ( t , {f}_{1} ) + … + {\sum }_{∀ t @ {f}_{m}} PerfLoss ( t , {f}_{m} )$$

The minimum performance loss can be found by considering all possible combinations of tasks and frequencies. Each task is considered at each available frequency in the system frequency set F. The partition which produces the minimum performance loss over the entire task set is chosen. However, this approach has a number of shortcomings. The first is that the algorithm necessary to evaluate all possible combinations is computationally prohibitive for use in a kernel-based scheduler. Another problem is that the total performance loss metric described in equation 9 does not take into account the different priorities of tasks in the system. A high priority task may itself suffer a small performance loss, but that lost performance may impact other tasks or system performance parameters. To alleviate this problem, the total performance loss metric can be modified to take into account the priorities of the tasks involved. Equation 10 defines an exemplary performance loss metric calculation that accounts for task priorities that may be implemented in TFS 150:

$$equation 10 \text{:}$$

$$TotalPefLoss ( T , F ) = {\sum }_{∀ t @ {f}_{1}} p ( t , {f}_{1} ) * PerfLoss ( t , {f}_{1} ) + … + {\sum }_{∀ t @ {f}_{m}} p ( t , {f}_{max} ) * PerfLoss ( t , {f}_{m} ) .$$

where p(t,fᵢ) defines a task priority for weighting of individual task performance losses based on the task priority. In this particular embodiment, to make equation 10 correct without additional modifications, the p(t, fᵢ) must all be non-negative and have the property that larger values represent higher priorities. In some data processor systems, such as a real-time system, p(t,fᵢ) may depend on the particular processor frequency and be different for different frequencies in F.

In one embodiment of the present invention, MP system 100 may include processors 120-123 running at set frequencies, and in such a configuration, a system frequency set F is readily identified. In such an implementation, the predictor may utilize a variant of the IPC prediction equation described in equation 3 and the performance loss metric of equation 8 to solve for an ideal frequency, f_{ideal}, at which an optimal performance of a task phase execution may be achieved. The ideal frequency f_{ideal} may be obtained from performance counter data recorded at the current frequency at which a task is executed. An exemplary calculation of the ideal frequency is defined by:

$$equation 11 \text{:}$$

$${f}_{ideal} = {f}_{max} if IPC > 1 ; otherwise \\ = \frac{Instructions * Perf ( t , {f}_{max} ) * ( 1 - ɛ )}{α * Instructions - α * {T}_{mem\_all} * Perf ( t , {f}_{max} ) * ( 1 - ɛ )} ,$$

where Tₘₑₘ_{_{—}}ₐₗₗ=N_{L2}T_{L2}+N_{L3}T_{L3}+NₘₑₘTₘₑₘ and ε is a small constant used to indicate how much performance loss will be tolerated. For example, an ε of 0.001 indicates a performance loss of 0.1% will be tolerated at f_{ideal}. A larger value of ε such as 0.01, indicates the system will tolerate larger performance losses. The value of ε is a parameter, which may be adjusted to ensure system performance meets required performance targets.

Alternatively, the predictor may calculate the predicted throughput performance at each of the available frequencies of the system frequency set to identify the highest frequency at which a throughput loss would occur.

The particular implementation of the multiprocessor system may be such that is not possible to schedule all tasks at their desired ideal frequency, due to, for example, power constraints. In such situations, it is necessary to make reasonable scheduling decisions based on additional criteria. It may be preferable that the criteria used for making scheduling decisions include performance loss and priority of the tasks under consideration for scheduling, although other considerations may be suitably substituted therefore.

FIG. 3 is a flowchart of an initialization subroutine of the task-to-frequency scheduling routine implemented in accordance with a preferred embodiment of the present invention. The initialization routine is preferably implemented as a set of instructions executed by a processing unit, such as one of processors 120-123 in FIG. 1. The initialization subroutine processing depicted in FIG. 3 is run after performance data has been recorded for tasks in the system, that is, after obtaining performance calculations for the task set at a particular frequency f of the system frequency set. The initial scheduling routine begins and reads a task set T (step 302). The routine then selects the first task to consider (step 303). The maximum performance (PerfMax) and the ideal frequency f_{ideal} are calculated for the current task (step 306). The maximum performance PerfMax may be calculated by the TFS by, for example, equation 6 using the highest processor frequency in the system frequency set F, and the ideal frequency is calculated per equation 11 described above. Alternatively, the performance may be calculated at each frequency of the system frequency set in the event that MP system 100 is implemented as a fixed frequency set system. In such an implementation, the lowest frequency of the frequency set F at which a performance loss less than ε is calculated is substituted for the ideal frequency as described in the present illustrative example.

Because the ideal frequency is unlikely to be available in the frequency set of the multiprocessor system, a desired frequency (f_{desired}) is then identified (step 308). As referred to herein, the desired frequency is the lowest available frequency that is greater than or equal to the ideal frequency. The performance metric Perf is then calculated for the current task at a stepped down frequency (f_{down}) (step 310). The stepped down frequency f_{down} is one frequency lower than f. In this case, f is f_{desired} and is thus the frequency at which a performance loss greater than or equal to ε has been predicted to occur in the event the task is performed at f_{down} rather than f_{desired}. The performance loss is then calculated for the current task at the stepped down frequency (step 312). The current task (along with the associated performance loss calculated at f_{down}) is then placed into a data object that is assigned to the desired frequency f_{desired}. As referred to herein, a data object into which tasks are placed by TFS is referred to as a bin and may be implemented, for example, as a linked list data structure, although other data structures may be suitably substituted therefore. The bin into which the task was placed is then sorted according to the performance loss at the stepped down frequency f_{down} (step 316), for example, from lowest to highest calculated performance loss. The initialization subroutine then evaluates whether additional tasks remain in the task set T for evaluation (step 318). If an additional task remains in the task set, the initialization subroutine selects a new task from the set of remaining tasks (step 320) then returns to calculate the maximum performance and ideal frequency for the remaining tasks according to step 306. If no additional tasks remain in the task set, the initialization subroutine cycle then ends.

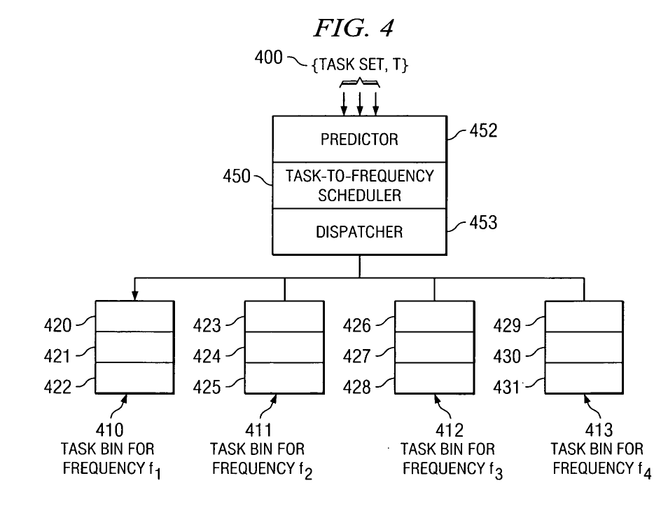

FIG. 4 is a diagrammatic illustration of task-to-frequency scheduler and task bins for initial task scheduling according to a preferred embodiment of the present invention. Task set 400 is read by predictor 452. Predictor 452 is an example of a predictor, such as predictor 152 shown in FIG. 1, that schedules tasks and, in conjunction with a scheduler and dispatcher, allocates tasks to a processor on a task-to-frequency basis. Each task is examined and evaluated per steps 306-316 as described above with reference to FIG. 3. Task bins 410-413 comprise data structure objects for storing and sorting tasks written thereto, for example a linked list data structure. Each of task bins 410-413 is associated with a frequency available in the multiprocessor system. In the illustrative example, the system has a slowest available processor frequency of f₁ and additional frequencies from f₂ to the highest processor frequency f₄ although any number of system processor frequencies may be accommodated. Task bin 410 is associated with the lowest available processor frequency f₁. Likewise, task bin 411 is associated with the second lowest available processor frequency f₂. Task bin 412 is associated with the next faster available processor frequency f₃, and task bin 413 is associated with the fastest available processor frequency f₄.

Each task bin 410-413 has available entries to which TFS 450 may write tasks. In the illustrative example, task bin 410 has task bin entries 420-422, task bin 411 has task bin entries 423-425, task bin 412 has task bin entries 426-428, and task bin 413 has task bin entries 429-431. The number of entries in a task bin may be dynamically adjusted as tasks are added or removed from the bins as well as added or removed from the set of tasks, and the task bin entry configuration shown in FIG. 4 is illustrative only. In accordance with one embodiment of the present invention, task bins 410-413 may have the same number of task bin entries to facilitate load balancing as described more fully below, although such an implementation is not necessary. TFS 450 places tasks in task bins 410-413 according to the desired frequency of the respective tasks as determined at step 308 in FIG. 3. Dispatcher 453 maps the tasks in the task bins 410-413 to the operating system queues, 180-183. Each processor or set of processors in the MP system 100 has an operating system data structure associated with it, which contains the information for all tasks which have been assigned to run on that processor or set. These data structures are referred to here as the “processor queues.” In Linux and some other operating systems, there is one processor queue for each processor. Each processor queue is actually a more complicated, composite structure consisting of simple queues because the operating system must take into account priorities as well as task fairness. However, in these illustrative examples, the queues are simply an operating system's method of representing the allocation of tasks to processors.

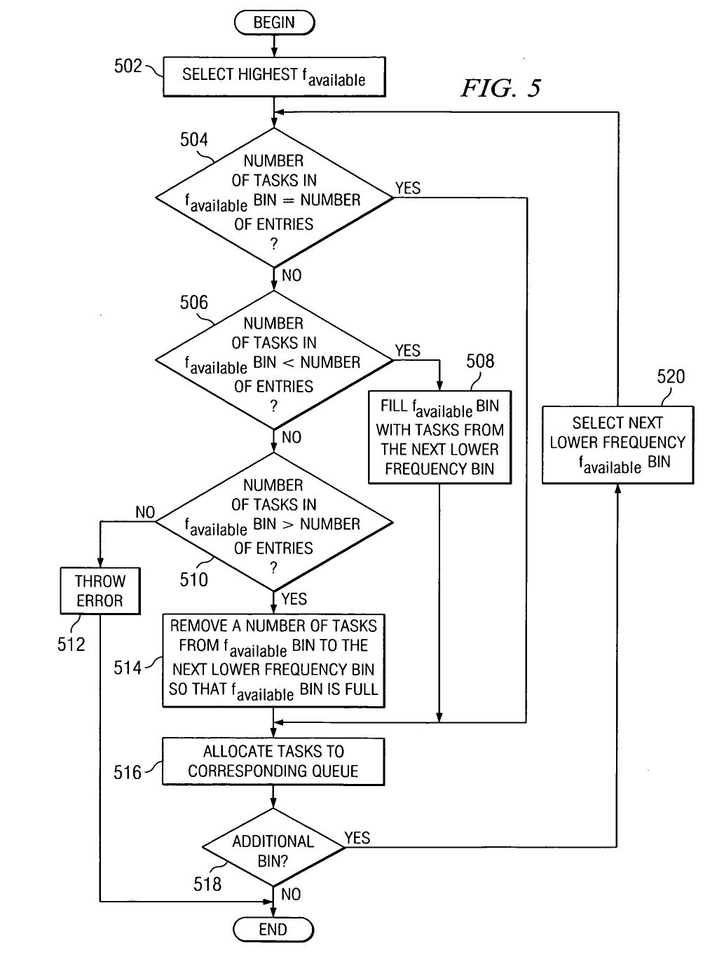

FIG. 5 is a flowchart depicting processing of the task-to-frequency scheduler subroutine for assigning tasks in task bins to processor queues in accordance with a preferred embodiment of the present invention. The task-to-frequency scheduler is preferably implemented as a set of instructions executed by a processing unit, such as processors 120-123 in FIG. 1. The task-to-frequency scheduler subroutine begins and selects the highest available frequency available, f_{available}, in the system (step 502). In this example, f_{available} is the selected frequency used for processing in the following steps. The number of tasks in the frequency bin corresponding to the selected frequency is then evaluated to determine if the number of tasks equals the number of bin entries (step 504). If the number of tasks in the task bin of the currently selected frequency equals the number of bin entries, the scheduling subroutine proceeds to allocate the tasks in the task bin to the queue corresponding to the currently selected frequency (step 516).

Returning again to step 504, if the number of tasks in the task bin that corresponds to the currently selected frequency does not equal the number of bin entries, the scheduling subroutine proceeds to determine if the number of tasks in the task bin is less than the number of task bin entries (step 506). If the number of tasks in the task bin of the currently selected frequency is less than the number of entries, the scheduling subroutine proceeds to fill the task bin of the currently selected frequency with tasks from the next lower frequency bin if one is available (step 508). In accordance with a preferred embodiment of the present invention, the tasks removed from the bin of the next lower frequency are selected based on their performance loss. Particularly, tasks are selected for removal from the task bin of the next lower frequency by selecting the task having the greatest performance loss calculated for the stepped down frequency and continuing with the one with the next greatest performance loss until a sufficient number of tasks have moved. In step 508, the goal is to minimize the performance lost at each level. By moving the tasks which suffer the largest potential performance loss to a faster frequency, the chances of large performance losses due to inadequate frequency are reduced. The scheduling subroutine then proceeds to allocate the tasks to the queue corresponding to the currently selected frequency according to (step 516).

Returning again to step 506, if the number of tasks in the task bin that corresponds to the currently selected frequency is not less than the number of bin entries, the scheduling subroutine proceeds to determine if the number of tasks in the task bin that corresponds to the currently selected frequency exceeds the number of task bin entries (step 510). If the number of tasks in the task bin corresponding to the currently selected frequency is not evaluated as exceeding the number of task bin entries, an exception is thrown (step 512), and the scheduling subroutine cycle then ends.

Returning again to step 510, if the number of tasks in the task bin corresponding to the currently selected frequency exceeds the number of task bin entries, the scheduling subroutine then proceeds to remove a number of tasks from the task bin so that the number of tasks in the task bin corresponding to the currently selected frequency equals the number of task bin entries (step 514). The tasks removed from the currently selected task bin are placed in the task bin at the stepped down frequency f_{down}. The tasks removed from the task bin of the currently selected frequency are selected based on the respective calculated performance penalties of the tasks in the currently selected task bin. That is, tasks are removed from the currently selected task bin by selecting the task with the smallest calculated performance penalty loss that is estimated to be incurred by executing the task at the next lower frequency, f_{down}. When a number of tasks have been removed and placed in the task bin of the next lower frequency so that the number of tasks in the task bin corresponding to the currently selected desired frequency equals the number of task bin entries, the scheduling subroutine then proceeds to allocate the tasks in the task bin to the corresponding processor queue according to step 516.

After tasks in the task bin corresponding to the currently selected frequency have been allocated to the corresponding processor queue, the scheduling subroutine then evaluates whether additional task bins remain for scheduling of the tasks (step 518). If additional task bins remain, the scheduling subroutine proceeds to select the next lower frequency (step 520), and then returns to step 504 to evaluate the number of tasks in the newly selected task bin. Otherwise, if no additional task bins remain, the scheduling subroutine cycle then ends.

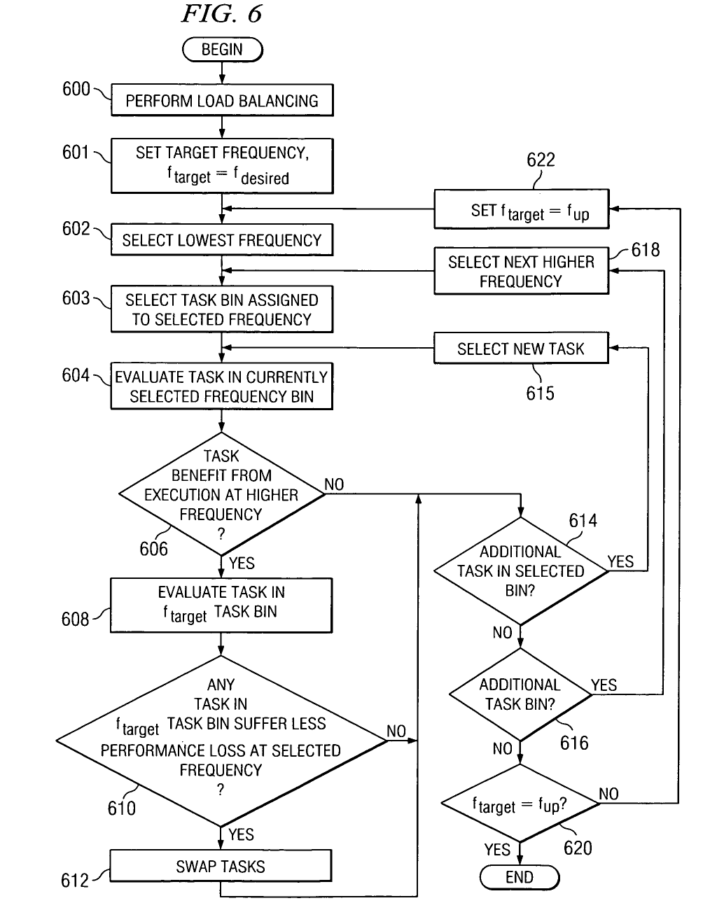

With reference now to FIG. 6, the drawing shows a scheduler which adjusts the assignment of tasks to processors using the task-to-frequency optimization in accordance with a preferred embodiment of the present invention. The balancing routine that ensures the minimization of performance loss is preferably implemented as a set of instructions executed by a processing unit, such as processors 120-123 in FIG. 1. A determination is made periodically as to whether it should be invoked. In some cases, it may not be needed, and the loss-minimization routine is not executed. In these illustrative examples, this routine is implemented in a scheduler, such as TFS 450 shown in FIG. 4.

The process begins in this illustrative embodiment by performing load balancing (step 600). The load balancing process is described in more detail in FIG. 5 above. Next, the method of selecting the target frequency, f_{target}, for each iteration of the following loop is to pick the desired frequency, f_{desired}, of the task under consideration during the iteration (step 601). Thereafter, the lowest frequency of the system frequency set F is selected (step 602). The task bin assigned to the selected frequency is then selected (step 603), and a task of the currently selected task bin is then evaluated to determine if the task would benefit from execution at a higher frequency (step 604). An evaluation of the performance penalty, i.e., the performance loss, calculated for the task at the frequency associated with the selected bin is made to determine if a performance penalty is incurred by executing the task at the frequency of the task bin to which the task is assigned. An evaluation is then made to determine if a performance benefit would be realized by executing the task at a higher frequency (step 606). If it is determined that no performance benefit would be realized by executing the task at a higher frequency, the loss-minimization routine proceeds to evaluate whether additional tasks remain in the currently selected frequency task bin (step 614).

Returning again to step 606, if it is determined that a benefit would be realized by executing the task at a higher frequency, one or more tasks of the target frequency (f_{target}) task bin are evaluated (step 608). An evaluation is made to determine if any task in the f_{target} task bin would suffer less performance loss by executing at the currently selected frequency than the current task evaluated for the selected frequency (step 610). If a task is identified in the f_{target} task bin that would incur a lesser performance penalty by executing the task at the selected frequency, the task in the selected frequency task bin is swapped with the task in the f_{target} task bin (step 612), and the balancing routine then proceeds to evaluate whether additional tasks remain in the currently selected frequency task bin according to step 614.

If it is determined at step 610 that no task in the f_{target} task bin would incur a lesser performance loss by execution at the currently selected frequency than the task of the currently selected frequency being evaluated, the balancing routine proceeds to determine if additional tasks in the currently selected frequency task bin remain for evaluation according to step 614.

If it is determined that an additional task remains in the currently selected frequency task bin at step 614, the balancing routine accesses the next task in the currently selected task bin at step 615 and continues, evaluating the next task in the currently selected frequency task bin according to step 604. If it is determined that no additional tasks remain in the currently selected frequency task bin at step 614, the balancing routine proceeds to determine whether additional task bins remain for evaluation (step 616). Preferably, task bins are evaluated from slowest frequency to fastest. In the event that another task bin remains for evaluation, the balancing routine proceeds to select the next higher frequency (step 618), and processing returns to step 603 to select the task bin assigned to the currently selected frequency. If it is determined that no additional task bins remain for evaluation at step 616, the process then determines whether the target frequency of f_{target} is equal to fᵤₚ, the next higher frequency above f_{target} unless f_{target} is f₄, the greatest available frequency (step 620). If the target frequency f_{target} is not equal to fᵤₚ, f_{target} is set to fᵤₚ (step 622) with the process then returning to step 602. This causes the process to reiterate through all of the steps described above for f_{target} equals fᵤₚ. When the process reaches step 620 with f_{target} equal to fᵤₚ, the process terminates because there are no remaining frequencies in F to consider.

In this manner, the present invention provides a method, apparatus, and computer instructions for identifying ideal processor frequencies for execution of an application phase in a multi processor system. In these illustrative embodiments, the processes and mechanisms described minimize performance penalties, reduce power and allow responses to be made to changes in memory subsystem demands.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although this embodiment shows the mechanism of the present invention to respond to fixed frequencies, this mechanism may be applied to respond to varying frequencies such as those changed by external agents or sources. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for predicting task and system performance at any processor frequency, wherein performance counter data regarding the processor and memory intensity of the tasks running on the processor are used as inputs for predicting the task and system performance at any processor frequency, the method comprising:
calculating the performance effect of the task's and system's memory behavior using cache and memory access counts together with known, fixed latencies to cache and memory and a count of instructions;
modifying the performance effect of the memory behavior using the frequency for which the prediction is being made;
calculating a performance effect of the processor behavior of the task and system using a representative value; and
determining a predicted performance using the frequency for which the prediction is being made to form a performance prediction.

2. The method of claim 1, wherein the performance prediction is conveniently approximated by a process in which in a first case of a task and system running at a high number of instructions per cycle that uses the said representative value; in a second case of the task and system running at a low number of instructions per cycle that uses the number of completed instructions divided by the product of total cache and memory time and the frequency for which the prediction is being made; and which process in either case multiplies results of either by the frequency for which the prediction is being made.

3. The method of claim 1, wherein the performance counter data for cache and memory consists of counts of processor cycles spent waiting for the cache and memory.

4. The method of claim 1, wherein a linear system is used to predict performance and wherein said linear system uses cache and memory performance counter data collected at two different frequencies and wherein said linear system is employed in computing environments where the latencies to cache and memory are not constant.

5. The method of claim 1, wherein the plurality of processors operate at a plurality of frequencies, and further comprising:
scheduling tasks to processors of different frequencies while minimizing performance lost versus operation at a nominal, maximum frequency due to the limitations on the number of available frequencies for a selected design parameter.

6. The method of claim 5, wherein the minimization of performance is optionally only to within some selected value of the true minimum value.

7. The method of claim 5, wherein the number of available frequencies is limited and wherein some of the plurality of processors operate at frequencies less than their nominal maximum to limit system power consumption.

8. The method of claim 7 further comprising the scheduling of tasks by weighting their performance loss in accordance with their assigned priorities.

9. The method of claim 8 wherein the assignment of tasks to frequencies, and thus to processors, is adjusted based on at least one of a performance gain and loss as tasks change their memory and processor behavior over time.

10. The method of claim 8 wherein the assignment of tasks to frequencies and, thus, to processors, is adjusted as a set of tasks to be scheduled changes through an addition of new tasks and a deletion of completed tasks.

11. The method of claim 8 wherein the load on the computing system is balanced in terms of the number of individual tasks assigned to each processor across the plurality of processors in the computing system.

12. The method of claim 8 wherein the plurality of processor frequencies changes at various times due to externally imposed changes in frequency and voltage and wherein assignment of tasks to frequencies and processors is adjusted to minimize performance loss given a newly available set of frequencies.

13. A computer program product for predicting task program and system performance at any processor frequency, wherein performance counter data regarding the processor and memory intensity of the tasks running on the processor are used as inputs for predicting the task and system performance at any processor frequency, the method comprising:
instructions for calculating the performance effect of the task's and system's memory behavior using cache and memory access counts together with known, fixed latencies to cache and memory and a count of instructions;
instructions for modifying the performance effect of the memory behavior using the frequency for which the prediction is being made;
instructions for calculating a performance effect of the processor behavior of the task and system using a representative value; and
instructions for determining a predicted performance using the frequency for which the prediction is being made to form a performance prediction.

14. The computer program product of claim 13, wherein the performance prediction is conveniently approximated by a process in which in a first case of a task and system running at a high number of instructions per cycle that uses the said representative value; in a second case of the task and system running at a low number of instructions per cycle that uses the number of completed instructions divided by the product of total cache and memory time and the frequency for which the prediction is being made; and which process in either case multiplies results of either by the frequency for which the prediction is being made.

15. The computer program product of claim 13, wherein the performance counter data for cache and memory consists of counts of processor cycles spent waiting for the cache and memory.

16. The computer program product of claim 13, wherein a linear system is used to predict performance and wherein said linear system uses cache and memory performance counter data collected at two different frequencies and wherein said linear system is employed in computing environments where the latencies to cache and memory are not constant.

17. The computer program product of claim 13, wherein the plurality of processors operate at a plurality of frequencies, and further comprising:
instructions for scheduling tasks to processors of different frequencies while minimizing performance lost versus operation at a nominal, maximum frequency due to the limitations on the number of available frequencies for a selected design parameter.

18. A data processing system that implements a method for predicting task and system performance at any processor frequency, wherein performance counter data regarding the processor and memory intensity of the tasks running on the processor are used as inputs for predicting the task and system performance at any processor frequency, the method comprising:
means for calculating the performance effect of task and system's memory behavior using cache and memory access counts together with known, fixed latencies to cache and memory and a count of instructions;
means for modifying the performance effect of the memory behavior using the frequency for which the prediction is being made;
means for calculating a performance effect of the processor behavior of the task and system using a representative value; and
means for determining a predicted performance using the frequency for which the prediction is being made to form a performance prediction.

19. The data processing system of claim 18, wherein the performance counter data for cache and memory consists of counts of processor cycles spent waiting for the cache and memory.

20. The data processing system of claim 18, wherein a linear system is used to predict performance and wherein said linear system uses cache and memory performance counter data collected at two different frequencies and wherein said linear system is employed in computing environments where the latencies to cache and memory are not constant.
